(19) United States
(12) Patent Application Publication
(10) Pub. No.: US 2005/0039867 A1
(43) Pub. Date: Feb. 24, 2005

(54) Advanced extendible window covering system for a vehicle

(76) Inventor: Hongbiao Li, Plano, TX (US)

Correspondence Address: MICHAEL L. DIAZ, P.C., 555 REPUBLIC DRIVE, SUITE 200, PIANO, TX, 75074, US

(21) Appl. No.: 10/952,153

(22) Filed: Sep. 28, 2004

Related U.S. Application Data
(63) Continuation-in-part of application No. 10/273,008, filed on Oct. 17, 2002.
Application No. 10/273,008 is a continuation-in-part of application No. 09/974,577, filed on Oct. 11, 2001, now abandoned.

(51) Int. Cl. B60J 3/00

(52) U.S. Cl. 160/370.22

(57) ABSTRACT

A window covering system for covering one or more windows of a vehicle is disclosed. The window covering system includes a plurality of retaining devices which slide along guide rails located on the perimeter of each window. A window covering, preferably composed of an elastomeric material, is attached to the retaining devices. The retaining devices and the window covering are opened and closed by sliding the retaining devices within the guide rails. The window covering completely covers the window in the closed position.

### RELATED APPLICATIONS

This application is a continuation-in-part of a co-pending U.S. patent application Ser. No. 09/273,008 entitled “EXTENDABLE WINDOW COVERINGS FOR A VEHICLE” filed Oct. 17, 2002 in the name of Hongbiao Li, which claims priority of U.S. patent application Ser. No. 09/974,577 entitled “RETRACTABLE WINDOW COVERINGS FOR AN AUTOMOBILE,” filed Oct. 11, 2001 in the name of Hongbiao Li, which is hereby incorporated in its entirety by reference herein.

### BACKGROUND OF THE INVENTION

1. Field of the Invention

This invention relates to vehicle coverings and, more particularly, to a window covering system providing a plurality of window coverings to fully cover a vehicle's windows.

2. Description of the Related Art

In hot climates, it is quite common for vehicles' interiors to become uncomfortably hot. Many times, the interior of a vehicle becomes so hot, that it is painful to touch various parts of the vehicle. In addition, any personal items stowed within the interior of the vehicle are susceptible to damage from excessive heat.

There have been many different devices utilized to reduce the heat within the interior of a vehicle exposed to the sun. One of the more popular items is the use of a cardboard sunshade positioned on the front windshield of the vehicle. This front windshield shade has helped in a limited way in reducing the heat on the front portion of the vehicle. The shade prevents the front dashboard and portions of the front seat from being exposed directly to the sun. However, the front windshield shade suffers from several disadvantages. First, positioning the front windshield shade in the proper position can be difficult. The shade must be expanded from a stored position and positioned under the windscreen mirror. This task may be difficult to accomplish. Second, the shade must be stored within the vehicle when not in use. There is no set position to store the shade, therefore, the shade is stored in various locations within the interior of the vehicle. At times, the shade may be hidden and difficult to find. Other times, the shade may be in the way, such as when the shade is stored on the back seat of the vehicle. If another individual desires to sit in the occupied seat, the shade must be moved. The shade also only prevents exposure of a portion of the interior of the vehicle. The sun can still shine into the other windows of the vehicle, causing the temperature of the vehicle's interior to still rise.

Although there are no known prior art teachings of a device such as that disclosed herein, a prior art reference that discuss subject matter that bears some relation to matters discussed herein is U.S. Pat. No. 5,316,363 to Tyutinman (Tyutinman). Tyutinman discloses an automobile window shade system for covering the windows of an automobile. However, Tyutinman does not teach or suggest a window cover system which completely covers the entire window. Because of the tapered shape of the window, the shade disclosed in Tyutinman does not teach or suggest covering the entire window.

There are no existing devices which completely covers a window and is easily deplored or stored. Thus, it would be a distinct advantage to have an apparatus which completely covers all the windows of the vehicle. It is an object of the present invention to provide such an apparatus.

### SUMMARY OF THE INVENTION

In one aspect, the present invention is a window covering system for use on a vehicle. The window covering system includes a perimeter surrounding a window of the vehicle. A first guide rail, having a groove, is attached to one side of the perimeter. A second guide rail is attached to an opposite side of the perimeter. The second guide rail also has a groove. The system also has a plurality of retaining devices. Each retaining device has a first end and a second end. The first end slidably engages within the groove of the first guide rail and the second end slidably engages the groove of the second guide rail. Each retaining device slides along the first and second guide rails. A window covering is attached to the plurality of retaining devices. The window covering is opened and closed by moving the retaining devices along the first and second guide rails.

In one embodiment, the present invention is a window covering system for use on a vehicle. The window covering system includes a perimeter surrounding a window of the vehicle. A first guide rail, having a groove, is attached to one side of the perimeter. A second guide rail is attached to an opposite side of the perimeter. The second guide rail also has a groove. The system also has a plurality of retaining devices. Each retaining device has a first end and a second end. The first end slidably engages within the groove of the first guide rail and the second end also slidably engages within the groove of the second guide rail. Each retaining device slides along the first and second guide rails. Each retaining device is telescopic, thereby allowing each retaining device to vary in length when slid along the first and second guide rails. Each retaining device is also connected to a cable for moving the plurality of retaining devices. A window covering is attached to the plurality of retaining devices. The window covering is constructed of an elastomeric material. The window covering is opened and closed by moving the retaining devices along the first and second rails. The window covering may cover the entire window of the vehicle in the closed position.

In another aspect, the present invention is a window covering system for use on a vehicle. The window covering system includes a perimeter surrounding a window of the vehicle. A first guide rail, having a groove, is attached to one side of the perimeter. A second guide rail is attached to an opposite side of the perimeter. The second guide rail also has a groove. The system has a plurality of retaining devices. Each retaining device has a first end and a second end. The first end slidably engages within the groove of the first guide rail and the second end slidably engages within the groove of the second guide rail. Each retaining device slides along the first and second guide rails. A window covering is attached to the plurality of retaining devices. The window covering has a plurality of slats with each slat being attached to at least one retaining device. The window covering is opened and closed by moving the retaining devices along the first and second rails.

### BRIEF DESCRIPTION OF THE DRAWINGS

FIG. 1 is an interior side view of a side door having a plurality of stowed window coverings located within a perimeter of a window frame of the side door;

FIG. 2 is an interior side view of FIG. 1 illustrating a plurality of slidable retaining devices located within grooves of two guide rails;

FIG. 3 is a side view of the guide rail for one curved side of a window within the door with the plurality of slidable retaining devices;

FIG. 4 illustrated a side view of the guide rail for a straight portion of a window of the door;

FIG. 5 illustrates an interior side view of the side door with a plurality of slatted window coverings in the partially raised position;

FIG. 6 illustrates an interior side view of the side door with the plurality of slatted window coverings in the fully raised position;

FIG. 7 is an interior view of a front windshield having a plurality of slated window coverings in the open retracted position;

FIG. 8 illustrates an interior view of the front windshield with a right side of the windshield covered by the plurality of slated window coverings.

FIG. 9 is an interior view of the front windshield having the plurality of slated window coverings in the closed position;

FIG. 10 illustrates a plurality of telescopic retainers in a partially closed position on a window of a vehicle; and

FIG. 11 illustrates the plurality of telescopic retainers in an open position on the window.

### DESCRIPTION OF THE INVENTION

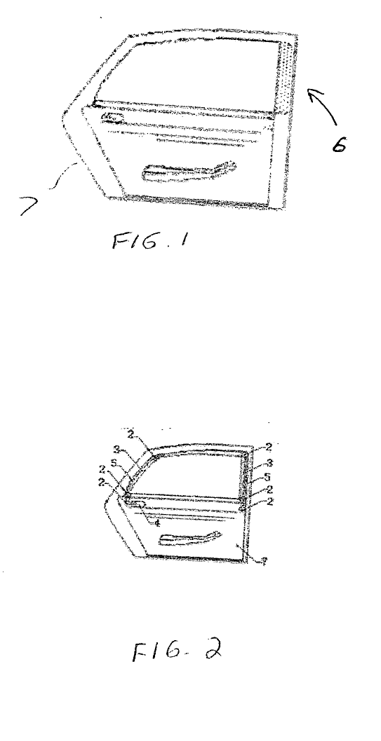

The present invention is an extendable window covering system for use on a vehicle. FIG. 1 is an interior side view of a side door 7 having a plurality of stowed window slatted coverings 6 located within a perimeter section frame of the side door. FIG. 2 is an interior side view of FIG. 1 illustrating a plurality of slidable retaining devices 2 located within grooves 5 of two guide rails 5.

FIG. 3 is a side view of the guide rail 3 for one curved side of a window within the door 7 with the plurality of slidable retaining devices 2. In addition, FIG. 3 depicts an actuating mechanism for moving the retaining devices 2. FIG. 4 illustrated a side view of the guide rail for a straight portion of a window of the door 3. Both FIGS. 3 and 4 illustrated that the guide rail may conform to any side of the window.

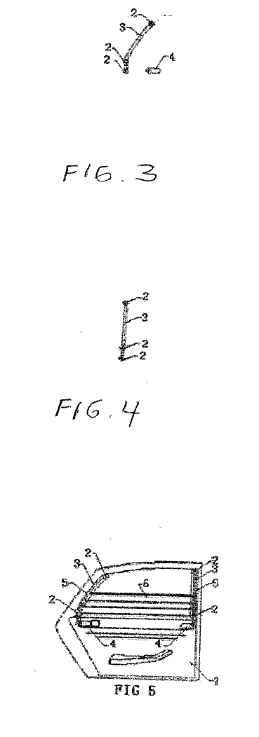

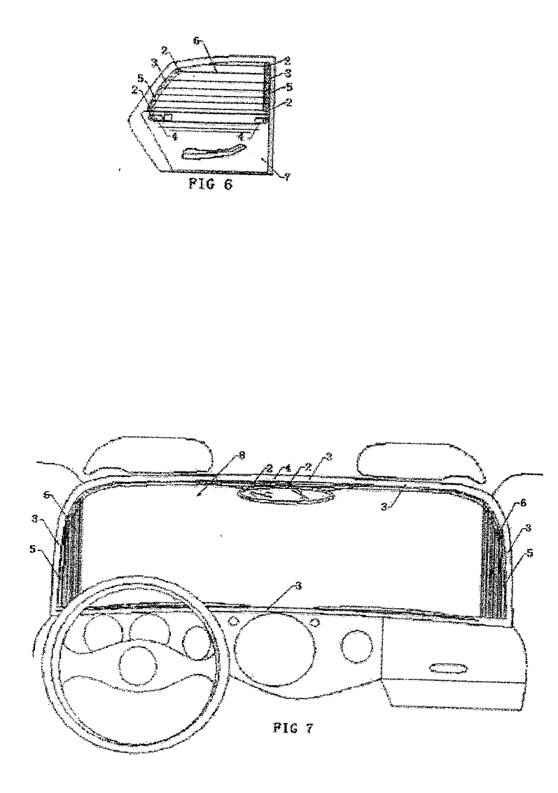

FIG. 5 illustrates an interior side view of the side door 7 with a plurality of slatted window coverings 6 in the partially raised position. FIG. 6 illustrates an interior side view of the side door 7 with the plurality of slatted window coverings 6 in the fully raised position. With the window coverings raised, the window of the door 7 is covered. The window coverings 6 may be raised and lowered in a similar manner that Venetian window blinds are deployed, except the illustrated example of the window coverings are horizontally arranged. The blinds may be moved by retaining each side of the covering by the slidable retaining devices 2 operating within the groove 5 of the guide rail 3. The retaining devices may be moved by a cable or cord within the groove attached to the retaining devices.

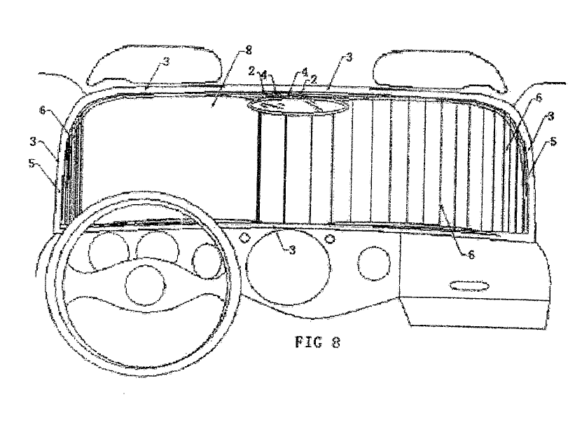

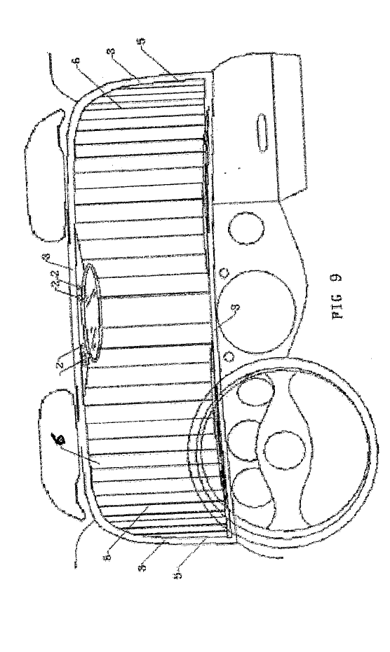

FIG. 7 is an interior view of a front windshield 8 having a plurality of slated window coverings 6 in the open retracted position. As depicted in FIG. 7, the window coverings are slide to the sides of the front windshield, thereby allow visibility out the front of the windshield. FIG. 8 illustrates an interior view of the front windshield with a right side of the windshield covered by the plurality of slated window coverings 6. FIG. 9 is an interior view of the front windshield having the plurality of slated window coverings in the closed position.

In a similar manner as discussed for FIGS. 1-6, the plurality of window coverings 6 for the front windscreen are guided from the open to the closed position by the slidable retaining devices 2 located within the grooves 5 of the guide rails 3. The retaining devices may be linked together by a cord or cable and slid together within the guide rails. The slatted window coverings 6 may be constructed of an elastomeric material, allowing the covering to stretch to accommodate various lengths as the covering is drawn across the window. In particular, the window has different lengths across its width. Thus, as the window shade is pulled open or closed, the window covering stretches or contracts as necessary to cover the full length of the window. As depicted in FIGS. 1-9, the retaining devices 2 are attached on opposite sides of the window covering, but are not necessary connected to each other.

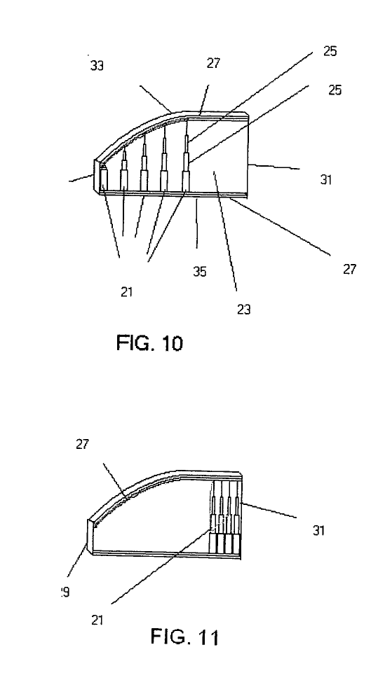

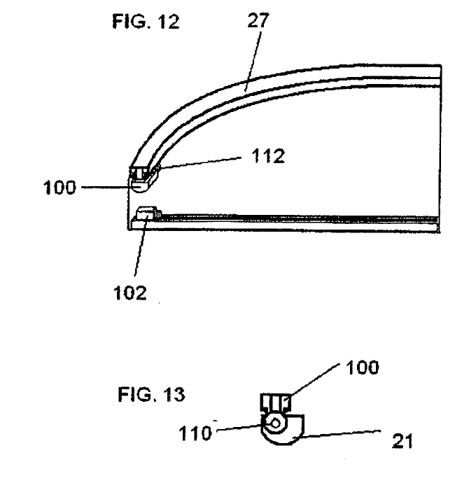

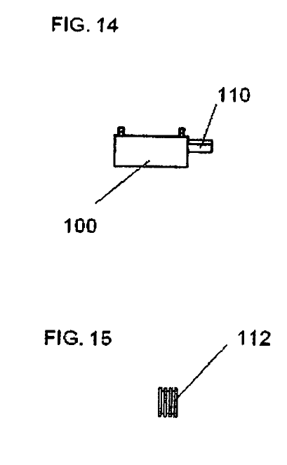

FIG. 10 illustrates a plurality of telescopic retainers 21 in a partially closed position on a window 23 of a vehicle. The telescopic retainers are attached to a guide rail 27 on a top perimeter 31 and a bottom perimeter 35. The telescopic retainer ends are affixed within a groove of the guide rails. The telescopic ends may slide freely from side to side along the guide rails. The telescopic ends may include retainer segments 25 which are telescopically coupled with adjacent segments, thus connect both ends of the retainers to each other. FIG. 11 illustrates the plurality of telescopic retainers in a open position on the window 23. The retainers are preferably affixed to a window cover (not shown). The window cover may be one piece of material or a plurality of slatted coverings, similar to FIGS. 1-9. If one piece of material is used, the material is preferably elastomeric to stretch to accommodate different lengths. Preferably, without any force being applied, the length of the window cover is less than the tapered end 29.

Unlike existing window covering devices for vehicles, the present invention provides a novel apparatus for completely covering a vehicle's window. As depicted in FIGS. 10 and 11, most conventional windows include both a tapered end 29 and a wide end 31. The window cover must conform to different sizes to enable complete coverage of the window. To move the window covering (not shown) from side to side, the retainers are affixed to the window covering. As the retainers are slid along each guide rail, the window cover moves correspondingly across the length of the window. Since the window includes both a tapered end 29 and a wide end 31, the retainers must accommodate different heights to properly hold the coverings in place and fully cover the window. As shown in FIG. 10, the telescopic retainer may extend out for the taller portions of the window. In addition, the retainers may compress to a shorter height along the tapered end. The retainer segments extend up or down to conform to the height of the window. In the preferred embodiment of the present invention, the segments are biased to a shorted length. The segments may be biased by utilizing springs to drive the segments to a compact configuration.

The window covering device of FIGS. 10 and 11 may also operate in a similar fashion as the window covering devices discussed in FIGS. 1-9. Specifically, the retainers may be connected to a cord or cable running in or adjacent the groove on each guide rail. The retainers may then be connected to each other. Thus, when pulling a portion of the window covering or retainer, the remaining retainers are also pulled. The retainers or window covering may be attached to a cord or cable which is driven to an open or closed configuration. The cord or cable may be driven by a motor (not shown).

In an alternate embodiment of the present invention, the retainers 21 may be composed of a stretchable or elastomeric material, such as a bungee cord. Thus, as the retainers slide along the guide rails, the cord stretches to the appropriate length.

The present invention enables window coverings to completely cover each window of a vehicle. The window coverings may be attached together and driven by a motor for opening and closing the window coverings.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A window covering system for use on a vehicle, the window covering system comprising:
a perimeter surrounding a window of the vehicle;
a first guide rail attached to one side of the perimeter, the first guide rail having a groove;
a second guide rail attached to an opposite side of the perimeter, the second guide rail having a groove;
a plurality of retaining devices, each retaining device having a first end and a second end, the first end slidably engaged within the groove of the first guide rail and the second end slidably engaged on the groove of the second guide rail;
each retaining device sliding along the first guide rail and the second guide rail;
a window covering attached to the plurality of retaining devices;
whereby the window covering is opened and closed by moving the retaining devices along the first and second guide rails.

2. The window covering system of claim 1 wherein each retaining device is telescopic, thereby allowing each retaining device to vary in length when slid along the first and second guide rails.

3. The window coveting system of claim 1, wherein each retaining device is composed of an elastomeric material, thereby allowing each retaining device to vary in length when slide along the first and second guide rails.

4. The window covering system of claim 1 wherein each retaining device is connected to a cable for moving the plurality of retaining devices.

5. The window covering system of claim 1 wherein the window cover is composed of an elastomeric material.

6. The window covering system of claim 1 wherein the window covering includes a plurality of slats, each slat being attached to at least one retaining device.

7. A window covering system for use on a vehicle, the window covering system comprising:
a perimeter surrounding a window of the vehicle;
a first guide rail attached to one side of the perimeter, the first guide rail having a groove;
a second guide rail attached to an opposite side of the perimeter, the second guide rail having a groove;
a plurality of retaining devices, each retaining device having a first end and a second end, the first end slidably engaged within the groove of the first guide rail and the second end slidably engaged on the groove of the second guide rail;
each retaining device sliding along the first guide rail and the second guide rail;
each retaining device being telescopic, thereby allowing each retaining device to vary in length when slid along the first and second guide rails;
each retaining device being connected to a cable for moving the plurality of retaining devices; and
a window covering attached to the plurality of retaining devices, the window covering being constructed of an elastomeric material;
whereby the window covering is opened and closed by moving the retaining devices along the first and second rails, the window covering covering the entire window of the vehicle in the closed position.

8. The window covering system of claim 7 wherein the window covering covers a front windscreen.

9. A window covering system for use on a vehicle, the window covering system comprising:
a perimeter surrounding a window of the vehicle;
a first guide rail attached to one side of the perimeter, the first guide rail having a groove;
a second guide rail attached to an opposite side of the perimeter, the second guide rail having a groove;
a plurality of retaining devices, each retaining device having a first end and a second end, the first end slidably engaged within the groove of the first guide rail and the second end slidably engaged on the groove of the second guide rail;
each retaining device sliding along the first guide rail and the second guide rail;
a window covering attached to the plurality of retaining devices, the window covering having a plurality of slats, each slat being attached to at least one retaining device;
whereby the window covering is opened and closed by moving the retaining devices along the first and second rails.

10. The window covering system of claim 1 wherein at least one retaining device is attached to a motor, the motor sliding on at least one guide rail, thereby driving the retaining device along the guide rail.
